(19) United States
(12) Patent Application Publication
(10) Pub. No.: US 2018/0176881 A1
(43) Pub. Date: Jun. 21, 2018

(54) Methods and Arrangements Regarding Paging of Wireless Communication Devices of a Certain Category

(71) Applicant: Telefonaktiebolaget LM Ericsson (publ), Stockholm (SE)

(72) Inventors: Tuomas Tirronen, Helsinki (FI); Erik Eriksson, Linköping (SE); Emre Yavuz, Stockholm (SE)

(21) Appl. No.: 15/127,275

(22) PCT Filed: Mar. 20, 2015
(86) PCT No.: PCT/SE2015/050336

§ 371 Date: Sep. 19, 2016

Related U.S. Application Data
(60) Provisional application No. 61/968,548, filed on Mar. 21, 2014.

(51) Int. Cl. H04W 68/02; H04W 8/22; H04W 4/06

(52) U.S. Cl. CPC H04W 68/02; H04W 4/70; H04W 4/06; H04W 8/22

(57) ABSTRACT

Methods and nodes relating to paging of one or more wireless communication devices (120a-b) of a certain category. A radio network node (110a) is comprised in a wireless communication network (100) and obtains (201; 301; 501) an indication that a wireless communication device (120a) is of said certain category. The radio network node (110a) and the wireless communication device (120a) derive (202; 302; 402; 502; 701), based on that the wireless communication device (120a) is of said certain category according to the obtained indication, a Radio Network Temporary Identifier (RNTI) for the wireless communication device (120a). The RNTI being based on that the wireless communication device (120a) is of said certain category. The radio network node (110a) sends (203; 303; 503) and the wireless communication device (120a) receives downlink control information with a cyclic redundancy check value scrambled with the derived RNTI.

### TECHNICAL FIELD

Embodiments herein relate to methods, a radio network node and a wireless communication device in a wireless communication network, e.g. telecommunication network. In particular embodiments herein relate to allocation of one or more paging messages for one or more wireless communication devices and to reception of one or more such paging messages.

### BACKGROUND

Communication devices such as wireless communication devices, that simply may be referred to as wireless devices, are also known as e.g. user equipments (UE), mobile terminals, wireless terminals, and/or mobile stations. Wireless devices are enabled to communicate wirelessly in a cellular communications network or wireless communication system, sometimes also referred to as a cellular radio system or cellular networks. The communication may be performed e.g. between two wireless devices, between a wireless device and a regular telephone and/or between a wireless device and a server via a Radio Access Network (RAN) and possibly one or more core networks, comprised within the cellular communications network.

Wireless communication devices may further be referred to as mobile telephones, cellular telephones, laptops, tablet computers or surf plates with wireless capability, just to mention some further examples. Wireless communication devices may be so called Machine to Machine (M2M) devices or Machine Type of Communication (MTC) devices, i.e. devices that are not associated with a conventional user.

The wireless devices in the present context may be, for example, portable, pocket-storable, hand-held, computer-comprised, or vehicle-mounted mobile devices, enabled to communicate voice and/or data, via the RAN, with another entity, such as another wireless device or a server.

The cellular communications network covers a geographical area which is divided into cell areas, wherein each cell area being served by a radio network node. A cell is the geographical area where radio coverage is provided by the radio network node.

The radio network node may e.g. be a base station such as a Radio Base Station (RBS), eNB, eNodeB, NodeB, B node, or Base Transceiver Station (BTS), depending on the technology and terminology used. The base stations may be of different classes such as e.g. macro eNodeB, home eNodeB or pico base station, e.g. based on transmission power and thereby also cell size.

Further, each radio network node may support one or several communication technologies. The radio network nodes communicate over the air interface operating on radio frequencies with the wireless terminals within range of the radio network node. In the context of this disclosure, the expression Downlink (DL) is used for the transmission path from the base station to the mobile station. The expression Uplink (UL) is used for the transmission path in the opposite direction i.e. from the mobile station to the base station.

3GPP has worked towards low cost LTE devices with reduced complexity in order to reduce the costs of these devices for mass Machine-to-Machine and/or Machine Type Communication (M2M/MTC) markets. One method to reduce the complexity is to reduce the bandwidth that is used, so that a UE needs to process only part of the bandwidth typically used in LTE networks. This reduction comes with a price of having less capacity for LTE control signaling and data transmission. For example, it has been discussed to specify a new category of UEs for which the maximum size of a transport block sent during one subframe is to be limited, effectively reducing the bandwidth in abovementioned fashion. These kind of UEs are typically M2M and/or MTC type of wireless devices, that are believed to be increasingly supported and occurring with the so called Internet of Things (IoT) evolution.

One of the procedures which can be affected by these complexity reductions is paging, which is used in the network when contacting a UE to indicate there is downlink data or other information targeted toward the UE. When a UE receives a paging message intended for it, it performs the necessary procedures to be able to receive the data, for example by initiating a random access procedure to a radio access network, in LTE to a eNB thereof, to establish a RRC connection.

In prior art LTE, UEs receive paging messages based on listening to a group identity named Paging Radio Network Temporary Identifier (P-RNTI). If the UE detects a P-RNTI on a control channel, it subsequently reads a paging message which is indicated on the control channel. With the reduced bandwidth, the number of UEs which can be addressed using one paging message is restricted compared to normal operation, and can be as low as one UE per one paging message. This may have an impact on also other UEs in a network and may significantly reduce the paging capacity of the network.

The possible limitation in the number of resource blocks, thus effectively the transmission bandwidth, restricts the number of UEs which can be paged in one message and one subframe. With the planned restrictions in LTE associated with the new category of UEs discussed above, it may happen that one paging message can only contain one UE identity. In this case, if a low cost UE needs to be paged, the network may need to postpone paging of other UEs which could be normally paged using a paging message with more UE identities. Thus, the paging capacity for all UEs can be reduced when the low cost UEs are introduced into the system.

Hence, there is a problem of limited paging capacity when there are low cost UEs as described above camped in a cell that support features of such UEs. That is, UEs where the low cost is accomplished by reduced complexity involving less capacity for LTE control signaling and data transmission, including limitation in maximum size of a transport block sent during one subframe.

### SUMMARY

An object is to provide one or more improvements with regard to paging of wireless devices in a wireless communication network, in particular an LTE network.

According to a first aspect of embodiments herein, the object is achieved by a method in a radio network node for allocating one or more paging messages for one or more wireless communication devices of a certain category. The radio network node being comprised in a wireless communication network. The radio network node obtains an indication that a wireless communication device is of said certain category. The radio network node then derives, based on that the wireless communication device is of said certain category according to the obtained indication, a Radio Network Temporary Identifier (RNTI) for the wireless communication device, which RNTI is based on that the wireless communication device is of said certain category. The radio network node sends, to one or more wireless communication devices, downlink control information with a cyclic redundancy check value scrambled with the derived RNTI.

According to a second aspect of embodiments herein, the object is achieved by a method in a wireless communication device in a wireless communication device for receiving one or more paging messages in a wireless communication network. Said wireless communication device being of a certain category. The wireless communication device derives a RNTI for the wireless communication device. The RNTI being based on that the wireless communication device is of said certain category. The wireless communication device receives, from a radio network node comprised in the wireless communication network, downlink control information with a cyclic redundancy check value scrambled with the derived RNTI.

According to a third aspect of embodiments herein, the object is achieved by a radio network node for allocating one or more paging messages for one or more wireless communication devices of a certain category. The radio network node is configured to be comprised in a wireless communication network. The radio network node is further configured to obtain an indication that a wireless communication device is of said certain category. Further, the radio network node is configured to derive, based on that the wireless communication device is of said certain category according to the obtained indication, a RNTI for the wireless communication device. The RNTI being based on that the wireless communication device is of said certain category. Moreover, the radio network node is configured to send, to one or more wireless communication devices, downlink control information with a cyclic redundancy check value scrambled with the derived RNTI.

According to a fourth aspect of embodiments herein, the object is achieved by a wireless communication device for receiving one or more paging messages in a wireless communication network. Said wireless communication device being of a certain category. The wireless communication device is configured to derive a RNTI for the wireless communication device. The RNTI being based on that the wireless communication device is of said certain category. The wireless communication device is further configured to receive, from a radio network node comprised in the wireless communication network, downlink control information with a cyclic redundancy check value scrambled with the derived RNTI.

Thanks to the provision of the derived RNTI, it is enabled to page wireless devices of said certain category, e.g. of the new category mentioned in the Background, separately from other, such as normal and/or so called legacy, wireless devices. Wireless devices of said certain category may be such UEs as discussed in the Background, e.g. low cost, low complexity, of M2M and/or MTC type of wireless devices, i.e. wireless devices that may have less capacity for LTE control signaling and data transmission, including limitation in maximum size of a transport block sent during one subframe.

Hence, embodiments herein, make it possible to more efficiently schedule paging messages using available radio resources. For example, the problem of limited paging capacity when there are wireless devices of said certain category camped in a cell that support such wireless devices can be reduced and need not affect other than these wireless devices. Hence, embodiments herein provide improvements with regard to paging of wireless communication devices in the wireless communication network.

### BRIEF DESCRIPTION OF THE DRAWINGS

Examples of embodiments herein are described in more detail with reference to the appended schematic drawings, which are briefly described in the following.

FIG. 1 is a block diagram schematically depicting an example of a wireless communication network in which embodiments herein may be implemented.

FIG. 2 is a combined signaling diagram and flowchart for describing embodiments herein.

FIG. 3 is an exemplary flowchart of a method in a radio network node.

FIG. 4 is an exemplary flowchart of a method in a communication device, such as a user device or node.

FIG. 5 is a flowchart schematically illustrating embodiments of a method in a first radio network node.

FIG. 6 is a block diagram for illustrating embodiments of the first radio network node.

FIG. 7 is a flowchart schematically illustrating embodiments of a method in a first wireless communication device.

FIG. 8 is a block diagram for illustrating embodiments of the first wireless communication device.

### DETAILED DESCRIPTION

Embodiments enclosed herein address the problem of limited paging capacity for the case when there are low cost UEs camped in a cell that support this feature.

Some details regarding Radio Network Temporary Identifiers (RNTIs) and paging, briefly mentioned in the Background, will first be discussed, thereafter will embodiments herein be further discussed.

RNTIs, are used in LTE radio access networks to identify particular UEs or group of UEs so that correct signaling and/or data is received by intended UEs. In LTE, the RNTIs are 16-bit identifiers and are either static, defined in the specifications, or dynamic, allocated by the eNB or calculated from other information. In 3GPP TS 36.321 “Medium access control (MAC) protocol specification, see version 12.0.0, section 7.1, table 7.1-1, different types of RNTIs are listed and associated with particular logical and transport channels. Thus, there are separate RNTIs used, for example, during random access process, for paging and for dynamic scheduling of data transmission.

The RNTI values are used in connection with (Enhanced) Physical Downlink Control Channels ((E)PDCCHs), where Downlink Control Information (DCI) is first used to calculate a 16-bit Cyclic Redundancy Check (CRC) value and the RNTI is then used to scramble the CRC. Thus, the RNTIs are not sent as-is, but the UEs implicitly detect them by using assigned RNTIs when trying to decode the downlink control channels.

Paging is a procedure where the network initiates a connection with the UE for example to notify of a system information change or for pending downlink data for the UE. The UE monitors the (E)PDCCH search spaces for P-RNTI during paging occasions (POs), which are calculated based on the UE identity, International Mobile Subscriber Identity (IMSI) and parameters configured by eNB. This calculation is specified in 3GPP TS 36.304 “User equipment (UE) procedures in idle mode” , see version 12.0.0, section 7. The current RNTI, which is used to indicate paging messages, is a group identity called Paging-RNTI P-RNTI) and its value is FFFE in hexadecimal.

Paging messages are defined in 3GPP TS 36.331 “Radio resource control (RRC) protocol specification”, see version 12.0.0, subsections 5.3.2 about paging procedure and 6.2.2 about paging message. The specification limits the number of UEs addressed in one paging message to 16. One entry is a combination of an identity of the UE (“ue-Identity”) and a core network domain (“cn-Domain”), where the size of “ue-Identity” can range from 24 bits up to 84 bits. “cn-Domain” is a one bit indication, thus the total size of one entry can be from 25 bits up to 85 bits. In the case the transmission bandwidth is limited and the information is sent using a low code rate, it may happen that the paging message consists of only one “ue-Identity”.

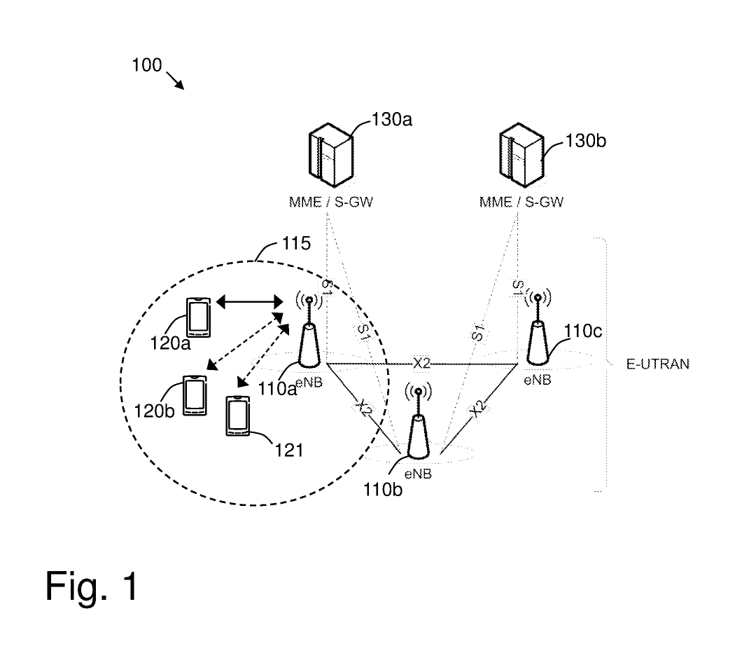

FIG. 1 depicts an example of a wireless communication network 100, e.g. a telecommunication network such as an LTE network, in the shown example based on architecture of an LTE network. The wireless communication network 100 comprises a cell 115, indicated in the figure by a perimeter of its coverage area. The cell 115, or at least radio coverage thereof, is provided by a first radio network node 110a , e.g. a first eNB in LTE, comprised in the wireless communication network 100. The wireless communication network 100 typically comprises further radio network nodes, e.g. a second radio network node 110b and a third radio network node 110c, e.g. second and third eNBs in LTE. In case of LTE, said eNBs are connected and may communicate with each other over so called X2 interfaces that are indicated in the figure. Said radio network nodes are typically associated with a Radio Access Network (RAN) part of the wireless communication network 100, in case of LTE in an Evolved Universal Terrestrial Radio Access Network (E-UTRAN) as indicated in the figure.

Further, the wireless communication network 100 typically comprise one or more core network nodes, e.g. a first core network node 130a and a second core network node 130b, e.g. Mobility Management Entity/ies (MME(s)) and/or or Serving GateWay(s) (S-GW(s)) as indicated in the figure and that may communicate with said radio network nodes over so called S1 interfaces, also indicated in the figure. Said core network nodes are typically associated with to core network part of the wireless communication network 100.

A first wireless communication device 120a and a second wireless communication device 120b are shown in the figure, as examples of wireless devices of a certain category. A third wireless communication device 121 is shown in the figure as an example of a wireless device that is not belonging to said certain category. Said certain category may e.g. be the new category mentioned in the Background, where support of said certain category in the wireless communication network 100 is associated with a resulting restriction of a number of wireless devices that can be paged in one paging message and in one subframe in the wireless communication network 100. Wireless devices, e.g. the first and second wireless devices 120a-b, of said certain category are typically low cost, and/or low complexity, wireless devices, that have a low cost and/or complexity compared to other wireless communication devices supported by the wireless communication network 100, e.g. the third wireless communication device 121.

Attention is drawn to that FIG. 1 is only schematic and for exemplifying purpose and that not everything shown in the figure may be required for all embodiments herein, as will be evident to the skilled person. Also, a wireless communication network that in reality corresponds to the wireless communication network 100 typically comprises several further network nodes, base stations, cells etc., as realized by the skilled person, but which are not shown herein for the sake of simplifying.

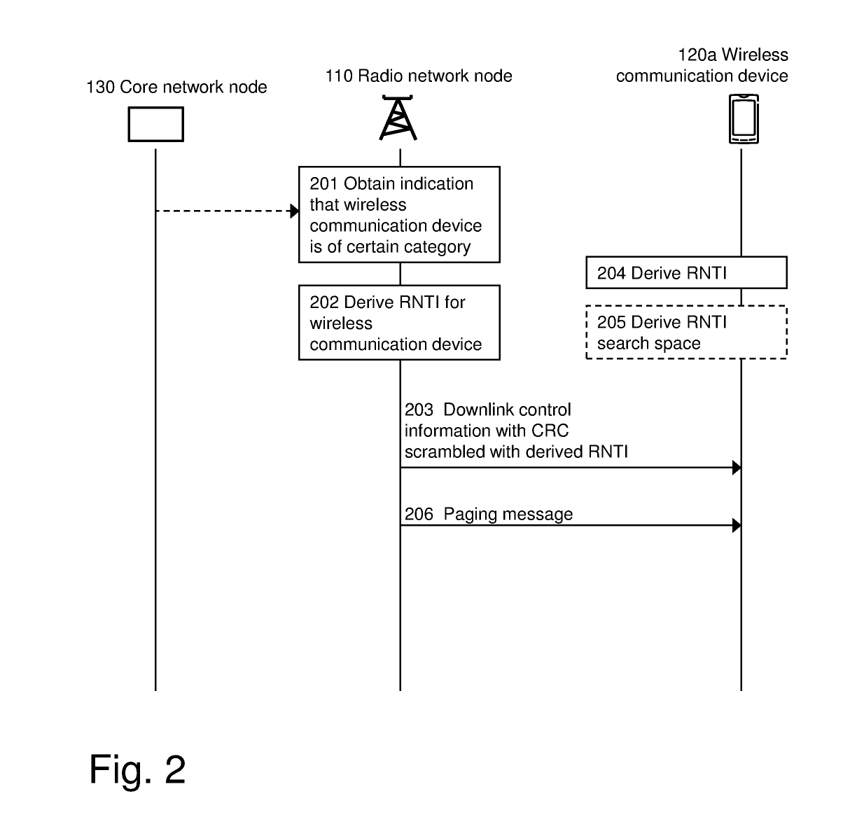

FIG. 2 depicts a combined signaling diagram and flowchart and will be used to discuss examples of method embodiments and related examples. The method embodiments are e.g. associated with a method in, e.g. performed by, a radio network node, exemplified by the first radio network node 110a, for allocating one or more paging messages for one or more wireless communication devices, e.g. the first wireless communication device 120a, of said certain category. Further, the method embodiments are e.g. also associated with a method in, e.g. performed by, a wireless communication device 120a, for receiving one or more paging messages in a wireless communication network, e.g. the wireless communication device 100.

The method embodiments comprise the following actions, which actions, as realized by the skilled person, may be taken in any suitable order and/or be carried out fully or partly overlapping in time when this is possible and suitable.

Action 201

A radio network node, exemplified by the first radio network node 110a, obtains an indication that a wireless communication device, herein exemplified by the first wireless communication device 120a, is of said certain category. In some embodiments, the indication is obtained by being received from a core network node, here the first core network node 130a, comprised in the wireless communication network 100.

The indication may thus be an indication to a RBS to use an alternative paging method, compared to a conventional paging method, where e.g. a new PM-RNTI (see below) is used to page low cost UEs. A flag or similar may be used to denote if a UE is a low cost UE. In some In one implementations this flag is sent from the first core network node 130a, e.g. a MME, to the first radio network node 110a, e.g. eNB. In other implementations the UEs low cost status is deduced from implicit information, where an example of such information is International Mobile Subscriber Identity (IMSI) or other user ID contained in a paging message or in the network node, e.g. MME, from which the indication, e.g. a message, is received.

Action 202

The first radio network node 110a derives, based on that the first wireless communication device 120a, is of said certain category according to the obtained indication, a RNTI for the first wireless communication device 120a. The RNTI being based on that the first wireless communication device 120a is of said certain category.

The RNTI may be defined to allocate paging messages to wireless communication devices of said certain category, such as the first and second wireless devices 120a-b, thereby enabling to page wireless communication devices of said certain category separately from other wireless communication devices, such as the third wireless communication device 121. In some embodiments, the RNTI is a Paging Machine Type Communication RNTI (PM-RNTI). That is, as realized by the skilled person, referring to paging of UEs that e.g. are M2M and/or M2C type of wireless devices as mentioned above. Thus also indicating that said category is associated with such wireless devices.

The RNTI may be predetermined or derived from an identity of the first wireless communication device 120a. Further, the RNTI may be the same for a group of wireless communication devices assigned to the RNTI, e.g. for wireless communication of said certain category and e.g. the same for both the first and second wireless communication devices 120a-b.

Detailed examples of how said RNTI can be determined and derived follow separately below.

Action 203

The first radio network node 110a sends, to one or more wireless communication devices, including e.g. the first wireless communication device 120a, Downlink Control

Information (DCI), for example by broadcast of the DCI in the cell 115. The first wireless communication device 120a receives the DCI. The DCI having a Cyclic Redundancy Check (CRC) value scrambled with the derived RNTI. Hence, the DCI may be sent in a conventional manner for paging purpose but using the derived RNTI, that may be said PM-RNTI, instead of a conventional RNTI for paging, such as the P-RNTI mentioned above.

Action 204

The first wireless device 120a derives a RNTI for the wireless communication device 120a, which RNTI is based on that the wireless communication device 120a is of said certain category. In other words, the first wireless device 120 derives the RNTI as well. As mentioned above, detailed examples of how said RNTI can be determined and derived follow separately below.

The first wireless device may then decode the received DCI based on assumption that the CRC is scrambled with the derived RNTI. That is, the wireless device uses the derived RNTI attempting to “descramble” the CRC of DCI and when/if the CRC become valid this indicates that the RNTI was used to scramble the CRC and that the DCI is for the first wireless device 120a.

Action 205

Additionally, the first wireless device 120a may derive, from the derived RNTI, a RNTI search space. The wireless communication device 120a may then use the RNTI search space to search downlink control channels for said DCI with CRC scrambled with the RNTI.

Detailed examples of the RNTI search space and how a wireless device, such as the first wireless device 110a, may use it to search downlink control channels follow separately below, after the detailed examples of how said RNTI can be determined and derived.

Action 206

The first radio network node 110a sends, on a downlink channel to one or more wireless communication devices, including the first wireless communication device 120a, a paging message intended for at least the first wireless device 120a. The first wireless communication device 120a receives the paging message.

Thanks to the provision of the derived RNTI, such as the PM-RNTI, it is possible to page UEs of said certain category, e.g. the first wireless communication device 120a, separately from other, such as normal and/or so called legacy UEs, e.g. the third wireless communication device 121. Wireless devices of said certain category may be such UEs as discussed in the Background, e.g. low cost, low complexity and/or M2M and/or MTC type of wireless devices, i.e. wireless devices that may have less capacity for LTE control signaling and data transmission, including limitation in maximum size of a transport block sent during one subframe.

Embodiments herein thus make it possible to more efficiently schedule paging messages using available radio resources. For example, the problem of limited paging capacity when there are wireless devices of said certain category, e.g. the first wireless communication device 120a, camped in a cell, e.g. the cell 115, that support such wireless devices can be reduced and need not affect other wireless devices, e.g. need no to affect paging of the third wireless communication device 121. At least not to the same extent that else would be the case. Hence, embodiments herein provide improvements with regard to paging of wireless communication devices in the wireless communication network 100.

Details and examples regarding how the above-mentioned RNTI, e.g. PM-RNTI, may be determined and derived will now follow.

In some embodiments, the PM-RNTI is derived from a UE identity, which may be IMSI or some other user identity. One way to do this is to use modular arithmetic to map different identities to a predetermined range of consecutive 16-bit patterns. This may be done by calculating IMSI (mod n)+a, where n denotes said predetermined range and a is an offset that provides a starting value. In some embodiments the range and offset are signaled from the network. In other embodiments the values are predetermined, e.g. fixed according to a standard.

Possible values for PM-RNTI may be defined in a standard specification, e.g. in a version of TS 36.321 “MAC”, and the network may allocate the identities to low cost UEs. In some embodiments the PM-RNTI group is signaled explicitly from a MME to eNB, e.g. from the first core network node 130a to the first radio network node 110a.

In some alternative embodiments, the allocation and a set of used values for PM-RNTI are broadcasted in system information messages. In a special case only a single PM-RNTI value may be assigned.

In some embodiments the PM-RNTI is signaled in a broadcasted message, in other embodiments it is fixed in a specification, i.e. predetermined. In some embodiments, presence of PM-RNTIs is signaled from the network.

In some embodiments both a UE, e.g. the first wireless communication device 120a, and the eNB, e.g. the first radio network node 110a, derive a PM-RNTI value or values using one of the above alternatives.

In other embodiments the eNB, e.g. the first radio network node 110a, derives or determines PM-RNTI values and signals or broadcasts the values to UEs, e.g. the first wireless communication device 120a. This signaling may be done using system information messages.

Details and examples regarding the above-mentioned RNTI search space and how a wireless device, such as the first wireless device 120a, may use it to search downlink control channels for the derived RNTI, e.g. PM-RNTI, will now follow. These details and examples is about a wireless device, e.g. the wireless communication device 120a, monitoring for the derived RNTI. As used herein, monitoring an RNTI may be the same as attempting to decode a DCI on a PDCCH or EPDCCH candidate assuming the CRC is scrambled with the RNTI.

In some embodiments, the search space the UE uses to search for downlink control channels for the PM-RNTI is derived from the PM-RNTI. The search space may be derived in the same way as a UE specific search space but using the PM-RNTI instead of a Cell RNTI (C-RNTI). In some embodiments, only candidates of higher aggregation levels may be monitored. A simplified mapping may be done using a PM-RNTI dependent mapping to a subset of the candidates of aggregation level 4 and/or 8, excluding common search space. This may for example be done using a modulus operation. In some embodiments, PM-RNTI may be sent on a common search space and on an additional search space. In some embodiments the UE, e.g. the first wireless device 120a, is only mandated to monitor the additional search space when it is in idle mode, e.g. does not have a C-RNTI assigned.

In other embodiments, the search space the UE, e.g. the first wireless device 120a uses, is fixed in one or more specifications, e.g. a standard specification, i.e. may be predetermined.

In some embodiments the search space is located on a different control channel from an ordinary common search space. In some embodiments said different control channel is an Enhanced Physical Downlink Control Channel (EPDCCH).

In some embodiments the UE, e.g. the first wireless device 120a, is mandated to monitor both for the P-RNTI and the PM-RNTI.

In some other embodiments the UE, e.g. the first wireless device 120a, is only mandated to monitor the PM-RNTI when in idle mode. In some embodiments P-RNTI is still monitored when in connected mode to detect SI-modification signaling. A network node of the wireless communication network 100 may utilize information about connected mode users of low cost type to limit the size of paging messages with SI-modification indication if such users are expected to monitor the message.

In some embodiments , the RNTI is not derived from the user ID but instead are physical resources to assume for paging reception derived from the user ID. In these embodiments, the UE, e.g. the first wireless communication device 120a, is not mandated to monitor for a scheduling assignment before attempting to decode the paging message instead it may attempt to decode the paging message using one or multiple assumptions on transport block size or other transmission parameters on the radio resource derived from the identity. In some embodiments such parameters for deriving the resources are signaled from the radio network. Such parameters may for example consist of assumed bandwidth for a paging message and/or assumed number of bits for a paging message.

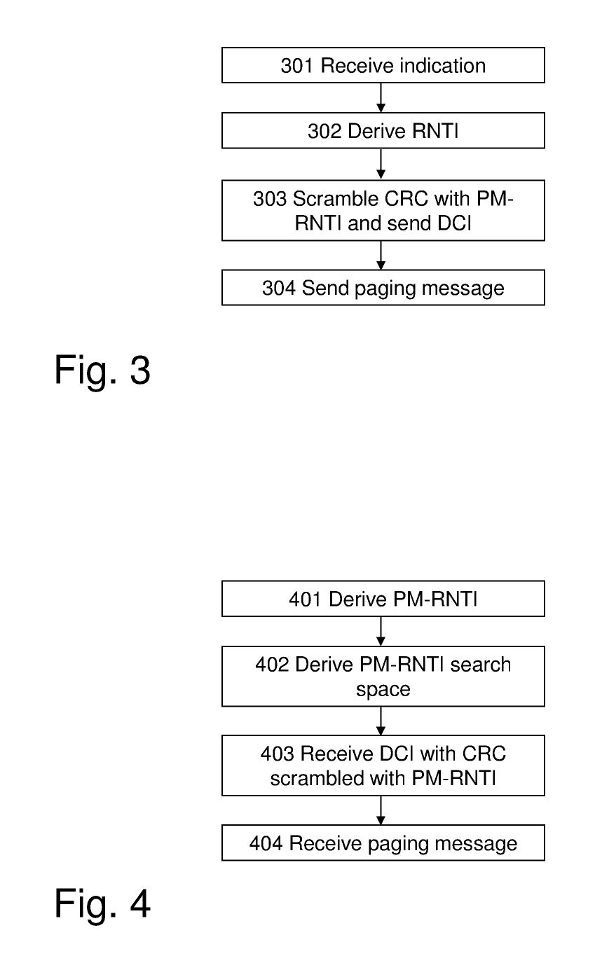

Some embodiments herein related to a method in a radio network node, such as an eNB, e.g. the first radio network node 120a, will now be exemplified with reference to the schematic flowchart of FIG. 3. It should be noted that the method steps shown and outlined below are optional and may be performed in any order other than the illustrated. The method may include the following steps.

The radio network node may, in an action 301, receive an indication from a core network node, such as a MME, e.g. the first core network node 130a, that the a communication device, e.g. the first wireless communication device 120a, is a low cost communication device, such as a low cost UE.

The radio network node may, in an action 302, derive an RNTI, such as a PM-RNTI, e.g. as discussed above, for one or more low cost communication devices, including e.g. the first wireless communication device 120a, that should be paged.

The radio network node may, in an action 303, scramble a CRC value of DCI with the derived RNTI and send the DCI including the scrambled CRC value on a downlink channel.

The radio network node may, in an action 304, sending a paging message, i.e. paging message intended for receipt by said one or more low cost communication devices.

Some embodiments herein related to a method in a low cost communication device, such as a low cost UE, e.g. the first wireless communication device 120a, will now be exemplified with reference to the schematic flowchart of FIG. 4. It should be noted that the method steps shown and outlined below are optional and may be performed in any order other than the illustrated. The method may include the following steps.

The low cost communication device may, in an action 401, derive an RNTI, such as PM-RNTI, e.g. as discussed above.

The low cost communication device may, in an action 402, derive a RNTI search space, such as a PM-RNTI search space, e.g. as discussed above, for searching downlink control channels.

The low cost communication device may, in an action 403, receive DCI including a CRC value scrambled with the derived RNTI from a radio network node, such as eNB, e.g. the first radio network nod 130a.

The low cost communication device may, in an action 404, receive a paging message on a downlink channel from the radio network node.

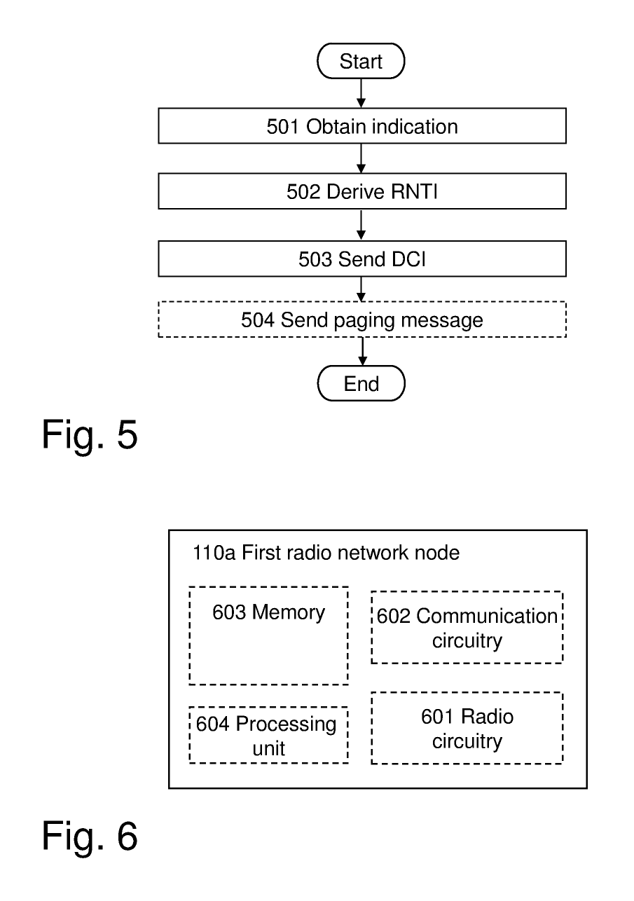

FIG. 5 is a flow chart schematically illustrating embodiments of a method in a radio network node, e.g. the first radio network node 110a, for allocating one or more paging messages for one or more wireless communication devices, e.g. the first and second wireless communication devices 120a-b, of a certain category. The radio network node is comprised in a wireless communication network, e.g. the wireless communication network 100.

The wireless communication network 100 may be an LTE network.

Said one or more wireless devices of the certain category may be low cost and/or low complexity wireless devices. Said low cost wireless communication devices having a low cost and/or low complexity compared to other wireless communication devices, e.g. the third wireless communication device 121, supported by the wireless communication network 100.

The method comprises the following actions, which actions may be taken in any suitable order and/or be carried out fully or partly overlapping in time when this is possible and suitable.

Action 501

The first radio network node 110a obtains an indication that a wireless communication device, e.g. the first wireless communication device 120a, is of said certain category.

In some embodiments, the indication is obtained by being received from a core network node, e.g. the first core network node 130a, comprised in the wireless communication network 100.

This action may fully or partly correspond to Action 201 and/or Action 301 above.

Action 502

The first radio network node 110a derives, based on that the first wireless communication device 120a is of said certain category according to the obtained indication in Action 501, a RNTI for the first wireless communication device 120a. The RNTI being based on that the first wireless communication device 120a is of said certain category.

In some embodiments, the RNTI is defined to allocate paging messages to wireless communication devices, e.g. the first and second wireless communication devices 120a-b, of said certain category. Thereby it is enabled to page wireless communication devices of said certain category separately from other wireless communication devices, e.g. the third wireless communication devices 121.

The RNTI may be a PM-RNTI.

Moreover, in some embodiments, the RNTI is predetermined or derived from an identity of the first wireless communication device 120a.

Furthermore, in some embodiments, the RNTI is the same for a group of wireless communication devices, e.g. comprising the first and second wireless communication devices 120a-b, assigned to the RNTI.

This action may fully or partly correspond to Action 202 and/or Action 302 above.

Action 503

The first radio network node 110a sends, to one or more wireless communication devices, e.g. the first and second wireless communication devices 120a-b, downlink control information with a cyclic redundancy check value scrambled with the derived RNTI.

This action may fully or partly correspond to Action 203 and/or Action 303 above.

Action 504

The first radio network node 110a may send, on a downlink channel to one or more wireless communication devices, e.g. the first and second wireless communication devices 120a-b, a paging message intended for at least said first wireless device 120a.

This action may fully or partly correspond to Action 206 and/or Action 304 above.

FIG. 6 is a schematic block diagram for illustrating embodiments of the radio network node mentioned above in connection with FIG. 5 and exemplified by the first radio network node 110a, in particular how the first radio network node 110a may be configured to perform the method and actions discussed above in connection with FIG. 5. In other words, what is shown is related to an apparatus to realize embodiments herein in practice, such as exemplified by FIG. 4 for a network node, such as eNB. The apparatus, in the shown example the first radio network node 110a, comprises, e.g. is arranged with, a radio circuitry 601 configured to e.g. communicate with served UEs, a communication circuitry 602 configured to e.g. communicate with other radio network and core network nodes, a memory 603 configured to store information related to embodiments herein, and a processing unit 604.

Therefore, according to the various embodiments described above, the first radio network node 110a, and/or the communication circuitry 602, may be configured to obtain said indication that the first wireless communication device 120a is of said certain category. The first radio network node 110a, and/or the communication circuitry 602, may be further configured to obtain the indication by receiving it from the first core network node 130a comprised in the wireless communication network 100.

For example, the communication circuitry 602 may be configured to receive from a core network node, such as the MME, e.g. the first core network node 130a, an indication that a communication device to be paged, e.g. the first wireless communication device 120a, is a low cost communication device, such as a low cost UE.

Moreover, according to the various embodiments described above, the first radio network node 110a, and/or the processing unit 604, may be configured to derive, based on that the first wireless communication device 120a is of said certain category according to the obtained indication, said RNTI for the first wireless communication device 120a. As mentioned above, the RNTI being based on that the first wireless communication device 120a is of said certain category.

For example, the processing unit 604 may be configured to derive a RNTI, such as PM-RNTI, for one or more low cost communication devices, including e.g, the first wireless communication device 120a, that should be paged. The processing unit 604 may be further adapted to scramble a CRC with the derived RNTI in downlink control information.

Further, according to the various embodiments described above, the first radio network node 110a, and/or the radio circuitry 601, may be configured to send, to said one or more wireless communication devices, e.g. e.g. the first and/or second wireless communication devices 120a-b, said downlink control information with the cyclic redundancy check value scrambled with the derived RNTI. The first radio network node 110a, and/or the radio circuitry 601, may be further configured to send, on said downlink channel to one or more wireless communication devices, said paging message intended for at least said first wireless device 120a.

For example, the radio circuitry 601 may be configured to send the DCI with the scrambled CRC on a downlink channel to one or more communication devices, including e.g. the first wireless communication device 110a. The radio circuitry 601 may be is further configured to send the paging message to the one or more communication devices.

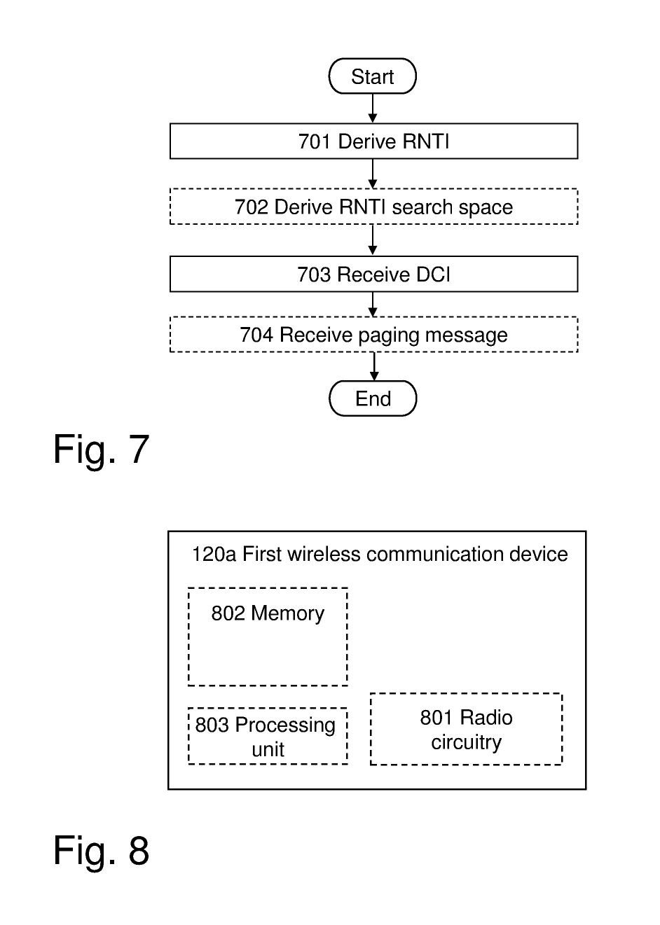

FIG. 7 is a flow chart schematically illustrating embodiments of a method in a wireless communication device, e.g. the first wireless communication device 120a, for receiving one or more paging messages in a wireless communication network, e.g. the wireless communication network 100.

The wireless communication network 100 may be an LTE network.

Said one or more wireless devices of the certain category may be low cost and/or low complexity wireless devices. Said low cost wireless communication devices having a low cost and/or low complexity compared to other wireless communication devices, e.g. the third wireless communication device 121, supported by the wireless communication network 100.

The method comprises the following actions, which actions may be taken in any suitable order and/or be carried out fully or partly overlapping in time when this is possible and suitable.

Action 701

The first wireless communication device 120a derives RNTI for the first wireless communication device 120a. The RNTI being based on that the wireless communication device (120a) is of said certain category.

In some embodiments, the RNTI is defined to allocate paging messages to wireless communication devices, e.g. the first and second wireless communication devices 120a-b, of said certain category. Thereby it is enabled to page wireless communication devices of said certain category separately from other wireless communication devices, e.g. the third wireless communication devices 121.

The RNTI may be a PM-RNTI.

Moreover, in some embodiments, the RNTI is predetermined or derived from an identity of the first wireless communication device 120a.

Furthermore, in some embodiments, the RNTI is the same for a group of wireless communication devices, e.g. comprising the first and second wireless communication devices 120a-b, assigned to the RNTI.

This action may fully or partly correspond to Action 204 and/or Action 401 above.

Action 702

The first wireless communication device 120a may derive, from the derived RNTI, a RNTI search space that the first wireless communication device 120a then uses to search downlink control channels for downlink control information with a cyclic redundancy check value scrambled with the RNTI .

This action may fully or partly correspond to Action 205 and/or Action 402 above.

Action 703

The first wireless communication device 120a receives, from a radio network node, e.g. the first radio network node 110a, comprised in the wireless communication network 100, said downlink control information with the cyclic redundancy check value scrambled with the derived RNTI.

The first wireless communication device 120a may decode the received downlink control information based on assumption that the cyclic redundancy check value is scrambled with the derived RNTI.

This action may fully or partly correspond to Action 203 and/or Action 403 above.

Action 704

The first wireless communication device 120a may receive, from the first radio 25 network node 110a and based on the received downlink control information, a paging message on a downlink channel, which paging message is intended for at least said first wireless device 120a.

This action may fully or partly correspond to Action 206 and/or Action 404 above.

FIG. 8 is a schematic block diagram for illustrating embodiments of the wireless communication device mentioned above in connection with FIG. 7 and exemplified by the first wireless communication device 120a, in particular how the first wireless communication device 120a may be configured to perform the method and actions discussed above in connection with FIG. 7. In other words, what is shown is related to an apparatus to realize embodiments herein in practice, such as exemplified by FIG. 8, such as for a low cost communication device, e.g. a low cost UE. The apparatus, e.g. a communication device, in the shown example the first wireless communication device 120a, comprises, e.g. is arranged with, a radio circuitry 801 configured to communicate with radio network nodes, a memory 802 configured to store information related to embodiments herein, and a processing unit 803.

Therefore, according to the various embodiments described above, the first wireless communication device 120a, and/or the processing unit 803, may be configured to derive said RNTI for the first wireless communication device 120a. That is, which RNTI is based on that the first wireless communication device 120a is of said certain category.

For example, the processing unit 803 may be configured to derive a RNTI, such as a PM-RNTI. The processing unit 803 may further be configured to derive a RNTI search space, such as a PM-RNTI search space, for searching downlink control channels.

Moreover, according to the various embodiments described above, the first wireless communication device 120a, and/or the radio circuit 801, may be configured to receive , from the first radio network node 110a comprised in the wireless communication network 100, said downlink control information with the cyclic redundancy check value scrambled with the derived RNTI. The first wireless communication device 120a, and/or the radio circuit 801, may be further configured to receive, from the first radio network node 110a and based on the received downlink control information, said paging message on said downlink channel. That is, which paging message is intended for at least said first wireless device 120a.

For example, the radio circuit 801 may be configured to receive downlink control information including CRC scrambled with the derived RNTI from a radio network node, such as eNB, e.g. the first radio network node 110a. The radio circuitry 801 may be further configured to receive a paging message on a downlink channel from the radio network node.

Further, according to the various embodiments described above, the first wireless communication device 120a, and/or the processing unit 803, may be further configured to decode the received downlink control information based on assumption that the cyclic redundancy check value is scrambled with the derived RNTI.

In view of the above, an object related to embodiments herein is allocation of paging messages for low cost communication devices, such as low cost LTE UEs. The following are various groups of embodiments based on the above.

According to a first group of embodiments herein, the object is achieved by a method in a radio network node for allocating paging messages for low cost communication devices. The radio network node receives an indication from a core network node, such as a MME, that a communication device is a low cost device. The radio network node then derives a RNTI, such as PM-RNTI described above, and sends a paging message on a downlink channel to one or more communication devices.

According to a second group of embodiments herein, the object is achieved by a method in a low cost communication device for receiving paging messages. The communication device derives a RNTI, such as PM-RNTI described above, and optionally derives a RNTI search space. The communication device receives downlink control information with a cyclic redundancy check scrambled with the RNTI. The communication device receives the paging message.

According to a third group of embodiments herein, the object is achieved by a radio network node adapted to allocate paging messages for low cost communication devices. The radio network node comprises a communication circuit adapted to receive an indication from a core network node, such as the MME, that a communication device is a low cost device. The radio network node further comprises a processing unit adapted to derive a RNTI, such as PM-RNTI described above. The radio network node also includes, radio circuitry adapted to send a paging message the one or more communication devices on a downlink channel.

According to a fourth group of embodiments herein, the object is achieved by a low cost communication device adapted to receive paging messages. The communication device comprises a processing unit adapted to derive a RNTI, such as PM-RNTI described above, and optionally to derive a RNTI search space. The communication device further comprises radio circuitry adapted to receive downlink control information with a cyclic redundancy check scrambled with the derived RNTI and to receive the paging messages.

According to some embodiments herein, a new RNTI, i.e. PM-RNTI, to allocate paging messages for low cost LTE UEs is defined. The PM-RNTI may be derived from the UE identity or may be fixed in e.g. LTE specifications. A group of UEs can be assigned to the same PM-RNTI.

Thanks to the derived RNTI, such as the PM-RNTI, it is enabled to page low cost UEs separately from other, such as normal and/or legacy UEs, making it possible to efficiently schedule paging messages using the available radio resources.

In the following, various aspects corresponding to currently non-claimed embodiments are described.

These embodiments e.g. relate to an additional and/or other method in a wireless communication device, e.g. the first wireless communication device 120a, for receiving one or more paging messages in a wireless communication network, e.g. the wireless communication network 100. The first wireless communication device 120a derives, from an identity of the first wireless communication device 120a, physical resources to assume for paging reception. The first wireless communication device 120a receives, from a radio network node, e.g. the first radio network node 110a, a paging message. The first wireless communication device 120a decodes the paging message based on the derived physical resources.

In some embodiments, the decoding uses one or more assumptions on transport block size or other transmission parameters on the derived radio resource.

Further, in some embodiments, the first wireless communication device 120a receives, from the wireless communication network 100, one or more of said other transmission parameters. The received transmission parameters may be with regard to, e.g. consist of, an assumed bandwidth for a paging message and/or assumed number of bits for a paging message.

As should be appreciated, for carrying out this additional and/or other method in the first wireless communication device 120a, the first wireless device 120a is configured to carry out the above method actions.

As should also be appreciated, these embodiments e.g. also relate to an additional and/or other method in a radio network node, e.g. the first radio network node 110a, for sending one or more paging messages in a wireless communication network, e.g. the wireless communication network 100, to one or more wireless devices, including the first wireless communication device 120a. The first radio network node 110a derives, from an identity of the first wireless communication device 120a, physical resources to use for at least one paging message. The first radio network node 110a sends, to one or more wireless devise including the first wireless communication device 120a, said at least one paging message using said physical resources.

In some embodiments, the first radio network node 110a sends, to the first wireless communication device 120a, one or more transmission parameters do be used for decoding said at least one paging message. The one or more transmission parameters may be with regard to, e.g. consist of, an assumed bandwidth for a paging message and/or assumed number of bits for a paging message.

Further, as should be realized, for carrying out this additional and/or other method in the first radio network node 110a, the first radio network node 110a is configured to carry out the above method actions.

Many details of examples above relate to LTE, i.e. are in a particular RAT context, and/or may have a specific meaning in such context, as recognized by the skilled person. However, embodiments herein are not limited to only such context(s) as used in the examples.

Note that although terminology used herein may be particularly associated with and/or exemplified by certain cellular communication systems, wireless communication networks etc., depending on terminology used, such as wireless communication networks based on 3GPP, this should not be seen as limiting the scope of the embodiments herein to only such certain systems, networks etc.

Also note that enumerating terminology such as first network node, second network node, first wireless device, second wireless device, etc., as such should be considering non-limiting and the terminology as such does not imply a certain hierarchical relation. Without any explicit information in the contrary, naming by enumeration should be considered merely a way of accomplishing different names.

As used herein, the expression “configured to” may mean that e.g. an apparatus is configured to, or adapted to, by means of software or hardware configuration, perform one or more actions.

As used herein, the terms “number”, “value” may be any kind of digit, such as binary, real, imaginary or rational number or the like. Moreover, “number”, “value” may be one or more characters, such as a letter or a string of letters. Also, “number”, “value” may be represented by a bit string.

As used herein, the expression “in some embodiments” has been used to indicate that the features of the embodiment described may be combined with any other embodiment disclosed herein.

As used herein, the expression “transmit” and “send” are typically interchangeable. These expressions may include transmission by broadcasting, uni-casting, group-casting and the like. In this context, a transmission by broadcasting may be received and decoded by any authorized device within range. In case of uni-casting, one specifically addressed device may receive and encode the transmission. In case of group-casting, e.g. multi-casting, a group of specifically addressed devices may receive and decode the transmission.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the present disclosure, which is defined by the appending claims.

1-38. (canceled)

39. A method in a radio network node for allocating one or more paging messages for one or more wireless communication devices of a certain category, the radio network node being comprised in a wireless communication network, wherein the method comprises:
obtaining an indication that a wireless communication device is of said certain category,
deriving, based on that the wireless communication device is of said certain category according to the obtained indication, a Radio Network Temporary Identifier (RNTI) for the wireless communication device, which RNTI is based on that the wireless communication device is of said certain category, and
sending, to one or more wireless communication devices, downlink control information with a cyclic redundancy check value scrambled with the derived RNTI.

40. The method of claim 39, wherein the RNTI is defined to allocate paging messages to wireless communication devices of said certain category, thereby enabling to page wireless communication devices of said certain category separately from other wireless communication devices.

41. The method of claim 39, wherein the RNTI is a Paging Machine Type Communication RNTI (PM-RNTI).

42. The method of claim 39, wherein the RNTI is predetermined or derived from an identity of the wireless communication device.

43. The method of claim 39, wherein the RNTI is the same for a group of wireless communication devices assigned to the RNTI.

44. The method of claim 39, wherein the method further comprises sending, on a downlink channel to one or more wireless communication devices, a paging message intended for at least said wireless device.

45. The method of claim 39, wherein said one or more wireless devices of the certain category are low-cost and/or low-complexity wireless devices, said low-cost wireless communication devices having a low cost and/or low complexity compared to other wireless communication devices supported by the wireless communication network.

46. The method of claim 39, wherein the indication is obtained by being received from a core network node comprised in the wireless communication network.

47. The method of claim 39, wherein the wireless communication network is a Long Term Evolution (LTE) network.

48. A method in a wireless communication device for receiving one or more paging messages in a wireless communication network, said wireless communication device being of a certain category, wherein the method comprises:
deriving a Radio Network Temporary Identifier (RNTI) for the wireless communication device, which RNTI is based on that the wireless communication device is of said certain category; and
receiving, from a radio network node comprised in the wireless communication network, downlink control information with a cyclic redundancy check value scrambled with the derived RNTI.

49. The method of claim 48, wherein the RNTI is defined to allocate paging messages to wireless communication devices of said certain category, thereby enabling to page wireless communication devices of said certain category separately from other wireless communication devices.

50. The method of claim 48, wherein the RNTI is a Paging Machine Type Communication RNTI (PM-RNTI).

51. The method of claim 48, wherein the RNTI is predetermined or derived from an identity of the wireless communication device.

52. The method of claim 48, wherein the RNTI is the same for a group of wireless communication devices assigned to the RNTI.

53. The method of claim 48, wherein the method further comprises:
receiving, from the radio network node and based on the received downlink control information, a paging message on a downlink channel, which paging message is intended for at least said wireless device.

54. The method of claim 48, wherein said one or more wireless devices of the certain category are low-cost and/or low-complexity wireless devices, said low-cost wireless communication devices having a low cost and/or low complexity compared to other wireless communication devices supported by the wireless communication network.

55. The method of claim 48, wherein the received downlink control information is decoded by the wireless communication device based on assumption that the cyclic redundancy check value is scrambled with the derived RNTI.

56. The method of claim 48, wherein the method further comprises:
deriving, from the derived RNTI, a RNTI search space, which RNTI search space the wireless communication device then uses to search downlink control channels for said downlink control information with cyclic redundancy check scrambled with the RNTI.

57. The method of claim 48, wherein the wireless communication network is a Long Term Evolution (LTE) network.

58. A radio network node for allocating one or more paging messages for one or more wireless communication devices of a certain category, the radio network node being configured to be comprised in a wireless communication network, wherein the radio network node is configured to:
obtain, an indication that a wireless communication device is of said certain category,
derive, based on that the wireless communication device is of said certain category according to the obtained indication, a Radio Network Temporary Identifier (RNTI) for the wireless communication device, which RNTI is based on that the wireless communication device is of said certain category, and
send, to one or more wireless communication devices, downlink control information with a cyclic redundancy check value scrambled with the derived RNTI.

59. The radio network node of claim 58, wherein the RNTI is defined to allocate paging messages to wireless communication devices of said certain category, thereby enabling to page wireless communication devices of said certain category separately from other wireless communication devices.

60. The radio network node of claim 58, wherein the RNTI is a Paging Machine Type Communication RNTI (PM-RNTI).

61. The radio network node of claim 58, wherein the RNTI is predetermined or derived from an identity of the wireless communication device.

62. The radio network node of claim 58, wherein the RNTI is the same for a group of wireless communication devices assigned to the RNTI.

63. The radio network node of claim 58, wherein the radio network node is further configured to:
send, on a downlink channel to one or more wireless communication devices, a paging message intended for at least said wireless device.

64. The radio network node of claim 58, wherein said one or more wireless devices of the certain category are low-cost and/or low-complexity wireless devices, said low-cost wireless communication devices having a low cost and/or low complexity compared to other wireless communication devices supported by the wireless communication network.

65. The radio network node of claim 58, wherein the radio network node is further configured to obtain the indication by receiving it from a core network node comprised in the wireless communication network.

66. The radio network node of claim 58, wherein the wireless communication network is a Long Term Evolution (LTE) network.

67. A wireless communication device for receiving one or more paging messages in a wireless communication network, said wireless communication device being of a certain category, wherein the wireless communication device is configured to:
derive a Radio Network Temporary Identifier (RNTI) for the wireless communication device, which RNTI is based on that the wireless communication device is of said certain category, and
receive, from a radio network node comprised in the wireless communication network, downlink control information with a cyclic redundancy check value scrambled with the derived RNTI.

68. The wireless communication device of claim 67, wherein the RNTI is defined to allocate paging messages to wireless communication devices of said certain category, thereby enabling to page wireless communication devices of said certain category separately from other wireless communication devices.

69. The wireless communication device of claim 67, wherein the RNTI is a Paging Machine Type Communication RNTI (PM-RNTI).

70. The wireless communication device of claim 67, wherein the RNTI is predetermined or derived from an identity of the wireless communication device.

71. The wireless communication device of claim 67, wherein the RNTI is the same for a group of wireless communication devices assigned to the RNTI.

72. The wireless communication device of claim 67, wherein the wireless communication device is further configured to:
receive, from the radio network node and based on the received downlink control information, a paging message on a downlink channel, which paging message is intended for at least said wireless device.

73. The wireless communication device of claim 67, wherein said one or more wireless devices of the certain category are low-cost and/or low-complexity wireless devices, said low-cost wireless communication devices having a low cost and/or low complexity compared to other wireless communication devices supported by the wireless communication network.

74. The wireless communication device of claim 67, wherein the wireless communication device is configured to decode the received downlink control information based on assumption that the cyclic redundancy check value is scrambled with the derived RNTI.

75. The wireless communication device of claim 67, wherein the wireless communication device is further configured to:
derive, from the derived RNTI, a RNTI search space, which RNTI search space the wireless communication device then uses to search downlink control channels for said downlink control information with cyclic redundancy check value scrambled with the RNTI.

76. The wireless communication device of claim 67, wherein the wireless communication network is a Long Term Evolution (LTE) network.
